(19) United States
(12) Patent Application Publication
(10) Pub. No.: US 2024/0198492 A1
(43) Pub. Date: Jun. 20, 2024

(54) Multi-Position Pliers With Elongated Recesses

(71) Applicant: Snap-on Incorporated, Kenosha, WI (US)

(72) Inventor: Daniel M. Eggert, Kenosha, WI (US)

(21) Appl. No.: 18/535,207

(22) Filed: Dec. 11, 2023

Related U.S. Application Data
(60) Provisional application No. 63/433,424, filed on Dec. 16, 2022.

(51) Int. Cl. B25B 7/10

(52) U.S. Cl. CPC B25B 7/10

(57) ABSTRACT

Adjustable pliers having a first plier half pivotably connected to a second plier half by a pivot pin; each plier half having gripping teeth, gripping grooves, and a gripping surface; wherein the second plier half includes second gripping teeth, second gripping grooves, and a second gripping surface; wherein the first plier half includes a first elongated recess positioned between the gripping grooves and the gripping surface, and the second plier half includes a second elongated recess positioned between the gripping grooves and the gripping surface; wherein when the first and second plier halves are in a closed position, a primary aperture is formed between the gripping teeth on the first plier half and the gripping teeth on the second plier half; and wherein a secondary aperture is formed between the elongated recess of the first plier half and the elongated recess of the second plier half.

### CROSS REFERENCE TO RELATED APPLICATION

This application claims the benefit of U.S. Provisional Application No. 63/433,424 entitled, “Multi-position Pliers with Elongated Recesses,” filed on Dec. 16, 2022, the entire contents of which is hereby incorporated.

### TECHNICAL FIELD

The present disclosure relates to adjustable tools, and more particularly to adjustable tools having distinct pivot centers linked by channels for altering jaw clamping width while providing equal gripping groves at each clamping width.

### BACKGROUND

Hand tools have evolved from single-use tools to adjustable tools adapted to accept workpieces having a wide range of sizes. That is, instead of changing to a bigger or smaller tool, a single tool could be adjusted to accommodate a larger or smaller sized workpiece, saving on time and the number of tools required for any given job. An example of such plier is set forth in U.S. Pat. No. 8,051,749 entitled “Positive Pivot Centers For Adjustable Tools” that issued on Nov. 8, 2011.

One such feature developed to make tools adjustable utilizes a slot incorporating multiple pivoting centers to adjust the jaws formed between the individual halves of an example hand tool such as a plier. A pivot attached to one half of the tool is capable of freely sliding between any number of centers connected through the slot. Typically, three pivoting centers are used to position the jaws at varying widths to engage small, medium and large workpieces.

When engaging a workpiece it is useful for the jaws formed between the individual halves to include working surfaces that are substantially parallel when engaged with a workpiece. However, it has been noted that working surfaces that include or incorporate a feature formed on each individual halves will not be aligned in each in each position of the jaws relative to the slot and the three pivoting centers.

### SUMMARY

The present disclosure relates to an adjustable tool which address the alignment challenges experienced by previous hand tools which include a feature formed on each individual halve. In particular, the present disclosure provides a hand tool including a feature aligned in each position of the jaws defined as part of each individual half relative to a pivot and a slot including three pivoting centers.

In one embodiment, an adjustable pliers is provided having first and second plier halves, each including a central section with a nose and a handle extending therefrom; each central section being pivotably connected to one another by a pivot pin attached to one of the plier halves and fitted for travel within a slot defined within the other of the plier halves; the slot comprising a plurality of pivot centers, including two non-adjacent terminal pivot centers and at least one intermediate pivot center, each pivot center being connected to at least one other pivot center by the slot to form a single pathway, whereby travel of the pivot pin between non-adjacent pivot centers requires travel through at least one of the at least one intermediate pivot centers; each nose of a plier half having an end distal from the central section and a work area adjacent the work area of the other plier, the work area defining substantially square shoulder indentation between 0.2″ and 1.50″ from the end; and the plier halves being configured so that, with the pivot pin in either of the terminal pivot centers and the adjustable tool in a working position, the work areas of each plier half are substantially parallel to one another and the shoulder indentations of each plier half are substantially aligned.

In another embodiment, adjustable pliers are provided having a first plier half and a second plier half, each including a central section with a nose and a handle extending therefrom; each central section being pivotably connected to one another by a pivot pin attached to one of the plier halves and fitted for travel within a slot defined within the other of the plier halves; the slot comprising a plurality of pivot centers, including two non-adjacent terminal pivot centers and at least one intermediate pivot center, each pivot center being connected to at least one other pivot center by the slot to form a single pathway, whereby travel of the pivot pin between non-adjacent pivot centers requires travel through at least one of the at least one intermediate pivot centers; wherein the first plier half includes first gripping teeth, first gripping grooves, and a first gripping surface; wherein the second plier half includes second gripping teeth, second gripping grooves, and a second gripping surface; wherein the first plier half includes a first elongated recess positioned between the gripping grooves and the gripping surface, and the second plier half includes a second elongated recess positioned between the gripping grooves and the gripping surface; wherein when the first and second plier halves are in a closed position, a primary aperture is formed between the gripping teeth on the first plier half and the gripping teeth on the second plier half; and wherein a secondary aperture is formed between the elongated recess of the first plier half and the elongated recess of the second plier half.

In another embodiment, an adjustable hand tool is disclosed. The adjustable hand tool includes a first tool half including a central section extending between a tool nose and a tool handle, wherein the central section includes a fixed pivot; a second tool half including a central section extending between a tool nose and a tool handle, wherein the central section includes a slot having a plurality of pivot centers, and wherein the slot and plurality of pivot centers are sized to slideably engage the fixed pivot thereby allowing travel along the slot; a first gripping surface positioned at the tool nose of the first tool half, wherein the first gripping surface includes a stepped recess positioned between a fine grip section and a coarse grip section; a second gripping surface positioned at the tool nose of the second tool half, wherein the first gripping surface includes a recess positioned between a fine grip section and a coarse grip section, wherein the recess is positioned substantially opposite to the stepped recess when the fixed pivot is engaged by the slot; and wherein the stepped recess and the recess define an aperture when the fixed pivot is positioned at one of the plurality of pivot centers, and a step of the stepped recess and the recess define another aperture when the fixed pivot is positioned at an adjacent one of the plurality of pivot centers.

In another embodiment, the adjustable hand includes the first tool half and the second tool half extending along a longitudinal axis between the tool nose and the tool handle.

In another embodiment, the adjustable hand tool of includes the stepped recess and the recess formed transverse to the longitudinal axis between the tool nose and the tool handle. In another embodiment, the tool handle includes a brake.

In another embodiment, the plurality of pivot centers specify an offset between two adjacent pivot centers defined as part of the plurality of pivot centers.

In another embodiment, the step of the stepped recess includes a width that is substantially equal to the offset.

In another embodiment, the recess is positioned substantially opposite to and aligned with the stepped recess when the fixed pivot is positioned one of the plurality of pivot centers.

In another embodiment, the recess is positioned substantially opposite to and aligned with the step of the stepped recess when the fixed pivot is positioned at the adjacent one of the plurality of pivot centers.

In another embodiment, the fixed pivot cooperates with a pivot pin nut to secure the first tool half to the second tool half.

In another embodiment, the fixed pivot is a shoulder bolt.

In another embodiment, the fine grip section of the first gripping surface and the second gripping surface is a fine serration.

In another embodiment, the coarse grip section of the first gripping surface and the second gripping surface is a coarse serration.

In another embodiment, the slot having the plurality of pivot centers further includes two non-adjacent terminal pivot centers and at least one intermediate pivot center, each pivot center being connected to at least one other pivot center by the slot to form a single pathway.

In another embodiment, the single pathway allows travel of the pivot pin between non-adjacent pivot centers via travel through at least one of the at least one intermediate pivot centers

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of an adjustable hand tool according to an example embodiment.

FIG. 2 is an exploded perspective view of the adjustable hand tool shown in FIG. 1.

FIG. 3 is a side view of the adjustable hand tool shown in FIG. 1 and FIG. 2.

FIG. 4 is a top view of the adjustable hand tool shown in FIGS. 1-3.

FIG. 5 is a side view of a first half of the adjustable hand tool shown in FIG. 1.

FIG. 6 is a bottom view of the first half of the adjustable hand tool shown in FIG. 1.

FIG. 7 is a side view of a second half of the adjustable hand tool shown in FIG. 1.

FIG. 8 is an enlarged perspective view of a nose of the first half of the adjustable hand tool shown in FIG. 5.

FIG. 9 is an enlarged, inverted perspective view of the nose of the first half of the adjustable hand tool shown in FIG. 1.

FIG. 10 is an enlarged view of a stepped recess positioned in the nose of the first half of the adjustable hand tool shown in FIG. 1.

FIG. 11 is an enlarged view of the stepped recess when the first half of the adjustable hand tool shown in FIG. 10 is in a second position relative to the pivot centers.

FIGS. 12A-12C are enlarged views of the nose of the adjustable hand tool positioned in multiple position to engage a workpiece.

FIGS. 13A-13C are enlarged views of the nose of another embodiment of an adjustable hand tool positioned in multiple position to engage a workpiece according to the present disclosure.

FIG. 14 is a perspective view of pliers 100 having plier half 110 and plier half 120.

FIG. 15 is an exploded perspective view of pliers 100 shown in FIG. 1.

FIG. 16 is a side view of pliers 100 shown in FIG. 1 and FIG. 2.

FIG. 17 is a top view of pliers 100 shown in FIGS. 1-3.

FIG. 18 is a side view of plier half 120.

FIG. 19 is a bottom view of plier half 120.

FIG. 20 is a side view of plier half 110.

FIG. 21 is a close-up view of the end of plier half 120.

FIG. 22 is a close-up view of an end of pliers 100.

FIG. 23 is a close-up view of an alternate end for pliers 100.

FIG. 24 is a side view of pliers 100 in three different positions.

FIG. 25 is a side view of another pliers in three different positions.

### DETAILED DESCRIPTION

The present disclosure relates an adjustable tool which incorporates a feature configured to maintain alignment across each adjustable position of the tool.

### I. An Adjustable Hand Tool with Alignable Groove

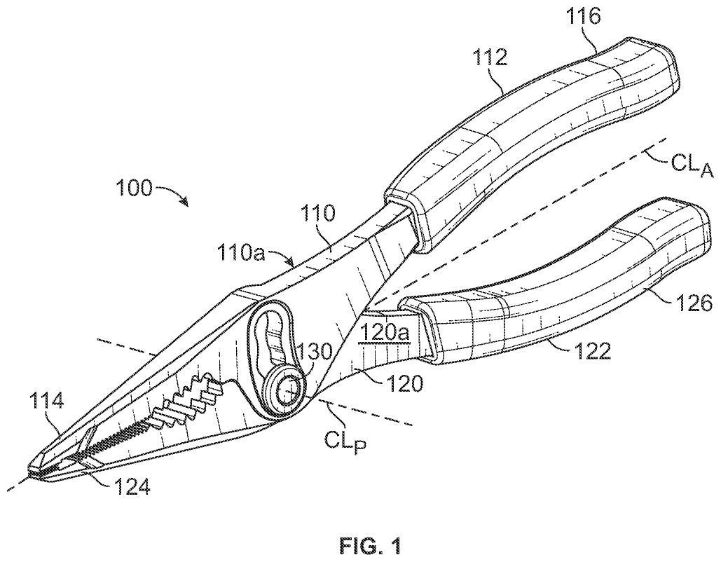

FIG. 1 shows an embodiment of an adjustable hand tool 100. The adjustable hand tool 100 includes a first half 110 pivotably coupled to a second half 120. As illustrated, the first half 110 is substantially mirrored by the second half 120 about the centerline CL_{A}. The first half 110 extends substantially linearly along the centerline CL_{A} and includes a handle 112 and a nose 114. The handle 112 positioned at one end of the first half 110 and the nose 114 positioned at the other end of the first half 110 distal to the handle 112. The handle 112 is formed to comfortably engage a user's hand and includes a brake 116. The brake 116 prevents the user's hand from slipping off the handle during high torque applications. In some examples, the handle 112 may be a molded handle enclosing the end of the first half 110. In some examples, the handle 112 may be knurled or otherwise machined and formed into the structure of the first half 110.

The second half 120, similar to the first half 110, extends substantially linearly along the centerline CL_{A} and includes a handle 122 and a nose 124. The handle 122 positioned at one end of the second half 120 and the nose 124 positioned at the other end of the second half 120 distal to the handle 122. The handle 122 is formed to comfortably engage a user's hand and includes a brake 126. The brake 126 prevents the user's hand from slipping off the handle during high torque applications. In some examples, the handle 122 may be a molded handle enclosing the end of the second half 120. In some examples, the handle 122 may be knurled or otherwise machined and formed into the structure of the second half 120.

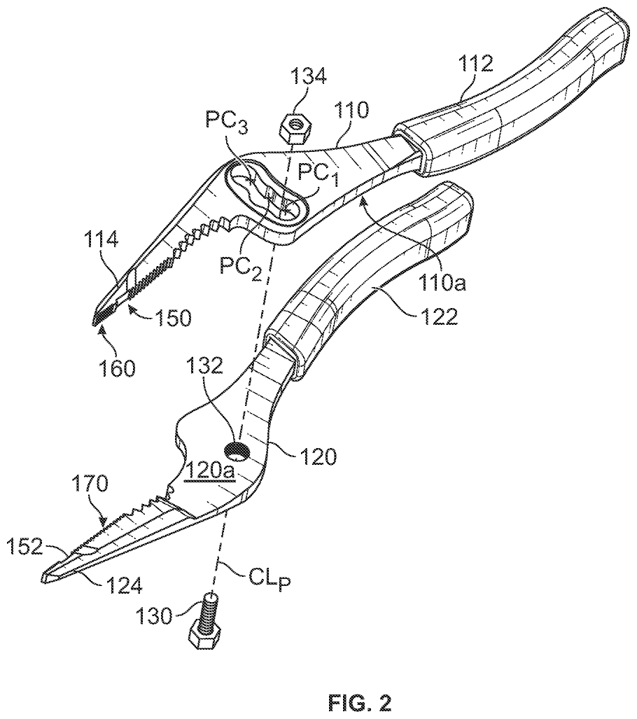

FIG. 2 shows that the first half 110 when pivotably coupled to the second half 120 is rotatable about a pivot 130 corresponding to centerline CL_{P}. When assembled for use, an inner surface 110a of the first half 110 is drawn onto slidable contact with an inner surface 120a of the second half 120. The pivot 130 may be a bolt that extends through a pivot hole 132 provided in the second half 120 and a slot 140 provided in the first half 110. For example, as shown in FIG. 4, a head 136 of the bolt may mechanically engage the first half 110 and a nut 134 may mechanically engage the bolt and the second half 120. Alternatively, the pivot hole 132 may be a tapped hole sized to receive, and mechanically secure, a threaded end of the bolt. In this way, the first half 110 and the second half 120 may be secured together about the pivot 130. In operation, a force applied by a user's hand via the handles 112 and 122 may be translated as a mechanical advantage to the nose 114 and nose 124 via the pivot 130.

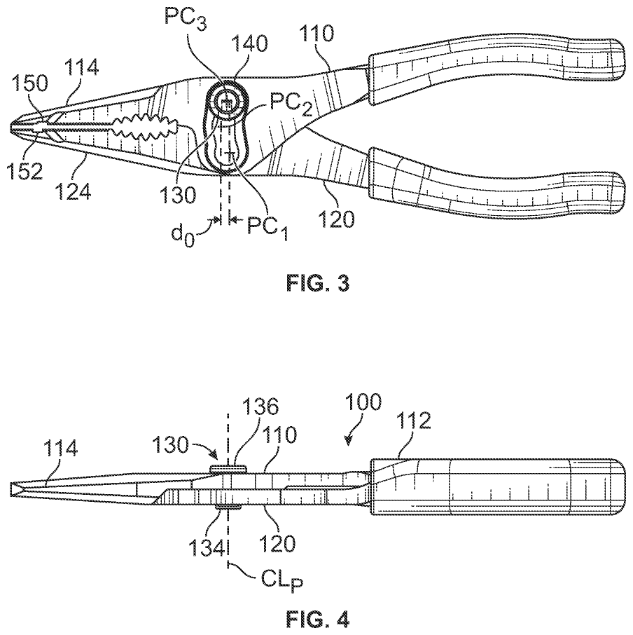

FIGS. 2-3 further show a stepped recess 150 formed as part of a gripping surface 160 defined in the nose 114 of the first half 110. Similarly, a corresponding recess 152 formed as part of a gripping surface 170 defined in the nose 124 of the second half 120. As shown in FIG. 3, the stepped recess 150 is substantially aligned with the recess 152 when the pivot 130 is aligned with the pivot center PC₁ formed as part of the slot 140. The slot 140 may include multiple pivot centers PC₁ to PC₃ arranged to form a single pathway sized to slidably accept the pivot 130. The pivot centers may be offset relative to each other such that the PC₁ to PC₂ is offset by a distance do, similarly the pivot centers PC₂ to PC₃ is offset by a distance do.

In some examples, the relative positions between the first half 110 and the second half 120 may be adjusted by locating the pivot 130 at one of the multiple pivot centers PC₁ to PC₃ arranged along the single pathway. For example, the nose 114 of the first half 110 may be offset by the distance do relative to the nose 124 of the second half 120.

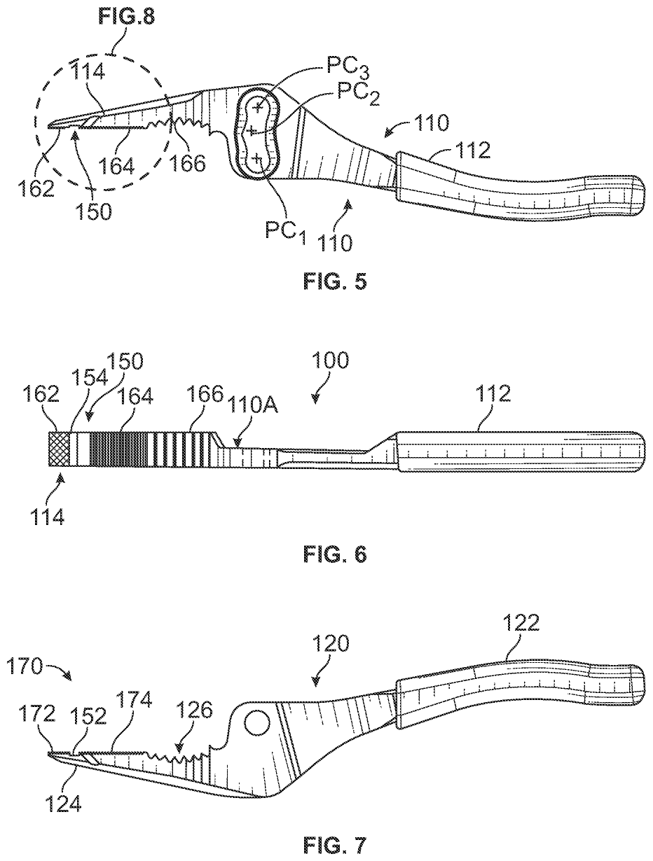

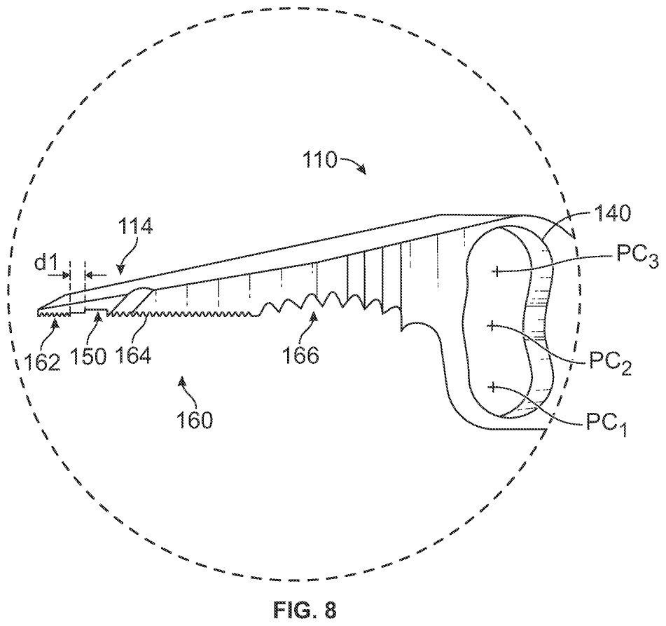

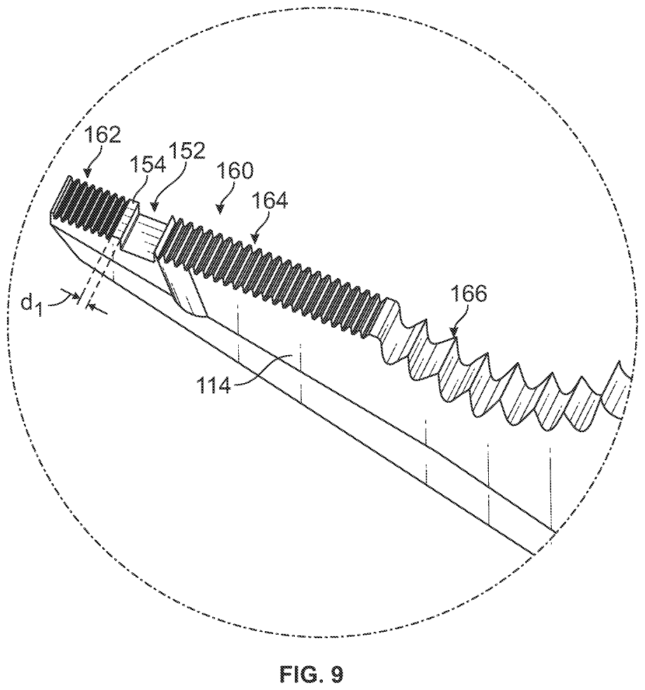

FIGS. 5-6 show a side view and bottom view of the first half 110, respectively. FIG. 5 shows a side view of the first half 110 including the slot 140 and the gripping surface 160 provided as part of the nose 114. Similarly, FIG. 6 shows a bottom view of the first half 110 including detailing the configuration of the gripping surface 160 provided as part of the nose 114. For example, as shown in FIG. 5, and in enlarged detailed in FIG. 8, the gripping surface 160 may include a fine grip section 162, a coarse grip section 164, and a workpiece section 166. The gripping surface 160 may be formed with the stepped recess 150 positioned between the fine grip section 162 and the coarse grip section 164. Similarly, the workpiece section 166 is position adjacent to the coarse grip section 164. FIG. 6. shows the arrangement of the fine grip section 162, the stepped recess 150, the coarse grip section 164, and the workpiece section 166 along the length of the first half 110. In some examples, the fine grip section 162 may defined by closely spaced grooves while the coarse grip section 164 may be defined by spaced grooves having a larger dimension than the closely spaced grooves. In some example embodiments, the grip sections 162, 164 may be configured to include one or more serrations or knurling. As shown in FIG. 8, the stepped recess 150 may include a step 154 having a width substantially equal to the distance d₁ defined between the pivot center PC₂ and either of the remaining pivot centers PC₁ or PC₃. As further illustrated in FIGS. 8 and 9, the stepped recess 150 is positioned above and does not interfere with the grip surface 160. For example, both the stepped recess 150 and the step 154 are position below a plane defined between the gripping surface 160 and both of the grip sections 162, 164. Accordingly, the gripping surface 160 as shown at least in FIGS. 8-9, are arranged to mechanically engage a workpiece before the stepped recess 150 when the adjustable hand tool 100 closes.

FIG. 7 shows a side view of the second half 120 including detailing the configuration of the gripping surface 170 provided as part of the nose 124. For example, the gripping surface 170 may include a fine grip section 172, a coarse grip section 174, and a workpiece section 176. The gripping surface 170 may be formed with the recess 152 positioned between the fine grip section 172 and the coarse grip section 147. Similarly, the workpiece section 176 is position adjacent to the coarse grip section 174. In some examples, the fine grip section 172 may be defined by closely spaced grooves while the coarse grip section 174 may be defined by spaced grooves having a larger dimension than the closely spaced grooves. In some example embodiments, the grip sections 172, 174 may be configured to include one or more serrations or knurling patterns. The recess 152 formed into the gripping surface 170 is configured to align with the stepped recess 150 when the first half 110 is positioned at pivot center PC₁, pivot center PC₂, and pivot center PC₃.

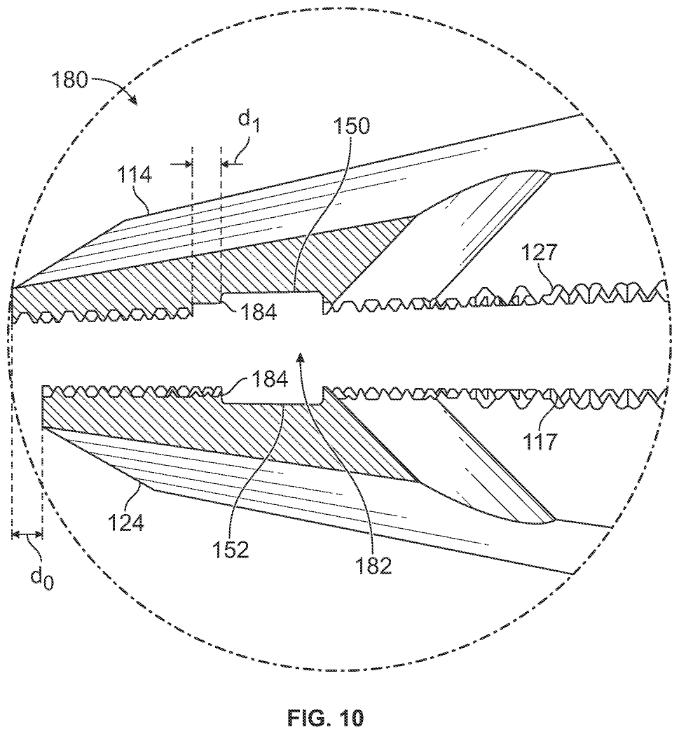

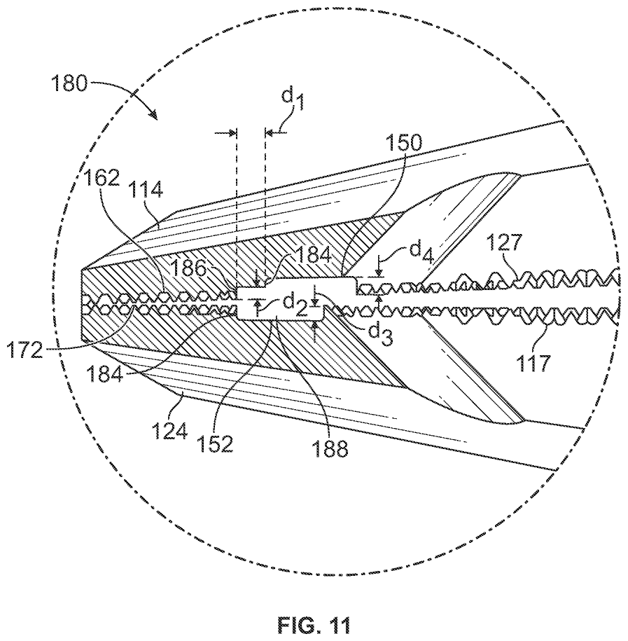

FIGS. 10 and 11 illustrate jaws 180 formed by the cooperation of the nose 114 of the first half 110 with the nose 124 of the second half 124. FIGS. 10 and 11 show the relative alignment of the first half 110 and the second half 120 as they traverse the slot 140 between pivots centers PC₁-PC₃ and cooperate to define the jaws 180. As shown in FIG. 10, when the jaws 180 are aligned such that the nose 114, 124 of the first half 110 and the second half 120 are not flush, then the pivot 130 is positioned at pivot center PC₂. The stepped recess 150 and the recess 152 are positioned to form a first aperture 182 having a substantially rectangular shape. In the illustrated alignment, the first aperture 182 includes a first wall 184 formed as part of the nose 114 and aligned with a first wall 184 formed as part of the nose 124. In this configuration, the first aperture 182 serves as a holding area for a workpiece to be held within the jaws 180 which allows for the workpiece to be more easily removed from, or inserted into, environments with a limited amount of space. Similarly, a workpiece with a head or ridge may be secured against the first wall 184 to further aid in the manipulation of the workpiece. For example, A workpiece having a uniform shape, such as a fuse, may mechanically engage an edge and line up with the first wall 184. In other embodiments, the step 154 may allow a uniform workpiece, such as a round bar or wirestock, to bear against the first wall 184 defined as part of the recesses 150, 152.

FIG. 11 is an enlarged view of the jaws 180 aligned when the first half 110 and the second half 120 are positioned at pivot center PC₁. For example, when the jaws 180 are aligned such that the nose 114, 124 of the first half 110 and the second half 120 are flush, them the pivot 130 is positioned at pivot center PC₁. It will be understood that a similar alignment with a different spacing between the first half 110 and the second half 120 of the jaws 180 may be achieved when they are positioned at pivot center PC₃. In the illustrated alignment, the step 154 extends from the end of the recess to form overall profile of the stepped recess 150. It will be understood that the distance d₁ of the step 154 is substantially the same as the distance do between the pivot centers PC₁ to PC₂, and PC₂ to PC₃. In this configuration, while the first half 110 and the second half 120 are offset when the pivot 130 engages either of the at pivot centers PC₁ and PC₃, the step 154 extends from the recess 150 and ends at a point that is aligned above the first wall 174 of the recess 152. In other words, a second wall 186 formed as part of the step 154 is aligned with the first wall 184 of the recess 152. The cooperation of the stepped recess 150 including the step 154 and the recess 152 define a second aperture 188. In the illustrated configuration of FIG. 10, the alignment of the first wall 184 of the recess 152 and the second wall 186 of the stepped recess 150 are aligned such that the secondary aperture 188 is half-offset relative to the configuration of the first aperture 182. It will be understood that the additional space afforded by the first wall 184 as part of the first aperture 182 ensures that an irregular workpiece, i.e., one having a non-uniform shape such as fuse, can mechanically engage the first wall 184 and the second wall 186 while the head or other feature is secured within the secondary aperture 188. In this way, a workpiece having a non-uniform shape can align with and engage features of the first half 110 and the second half 120 in each of the pivot centers PC₁-PC₃. Similarly, a workpiece such as round stock mechanically engage the stepped recess 150 and recess 152.

In one example configuration as shown in FIG. 11, the stepped recess 150 may be dimensionally defined to establish the second aperture 188. As discussed above, the distance d₁ of the step 154 is approximately the same as the distance do offsetting the pivot centers PC₁-PC₃. It will be understood that in other embodiments, the distance d₁ of the step 154 may be of varied length based on, for example, the desired application, and the offset distance between the pivot centers. In one embodiment, the distance d₂ shows the distance between the top of step 154 and the top of fine grip surface 162, distance d₃ shows the depth of the recess 152, and distance d₄ shows the depth of stepped recess 150. It will be understood that each of the distance d₁-d₄ may varied individually, or scaled as a group, and are shown only for exemplary purposes.

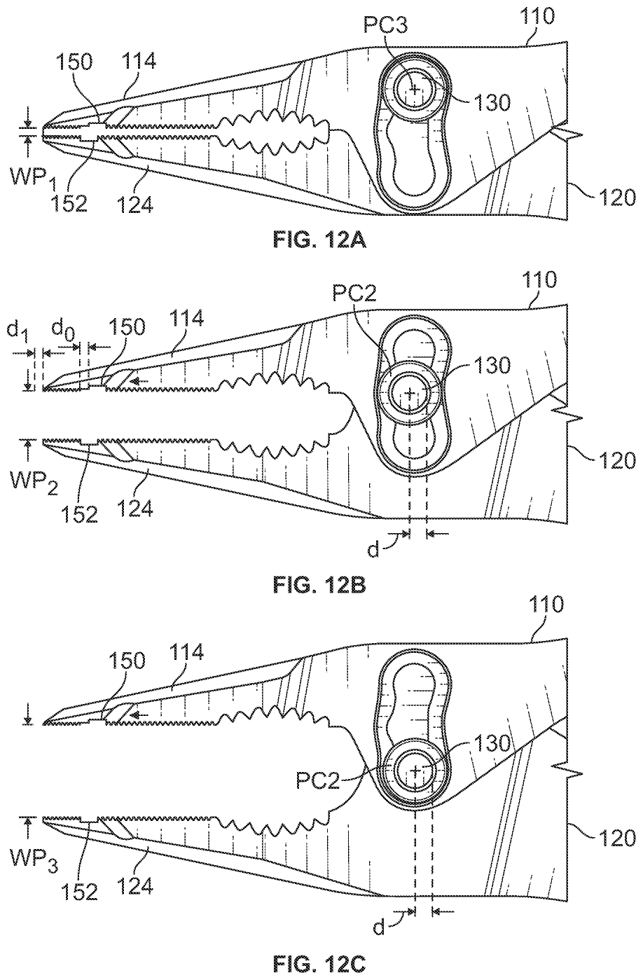

FIGS. 12A-12C shows three (3) enlarged views of the nose 114, 124 of the first half 110, and the second half 120, respectively. FIG. 12A illustrates the first half 110 and the second half 120 when the pivot 130 is aligned with PC₁ of the slot 140. In this arrangement, the nose 114 of the first half 110, and the nose 124 of second half 120 are substantially parallel and positioned to accept a workpiece of width WP₁. FIG. 12B illustrates the first half 110 and the second half 120 when the pivot 130 is aligned with PC₂ of the slot 140. In this arrangement, the nose 114 of the first half 110, and the nose 124 of second half 120 are substantially parallel and positioned to accept a workpiece of width WP₂. FIG. 12C illustrates the first half 110 and the second half 120 when the pivot 130 is aligned with PC₃ of the slot 140. In this arrangement, the nose 114 of the first half 110, and the 124 of second half 120 are substantially parallel and positioned to accept a workpiece of width WP₃. In each of the views A-C, the stepped recess 150 and the recess 152 are aligned such that the first wall 184 within each reference is aligned or that the first wall 184 of the recess 152 is aligned with the second wall 186 defines as part of the step 154 in the stepped recess 150.

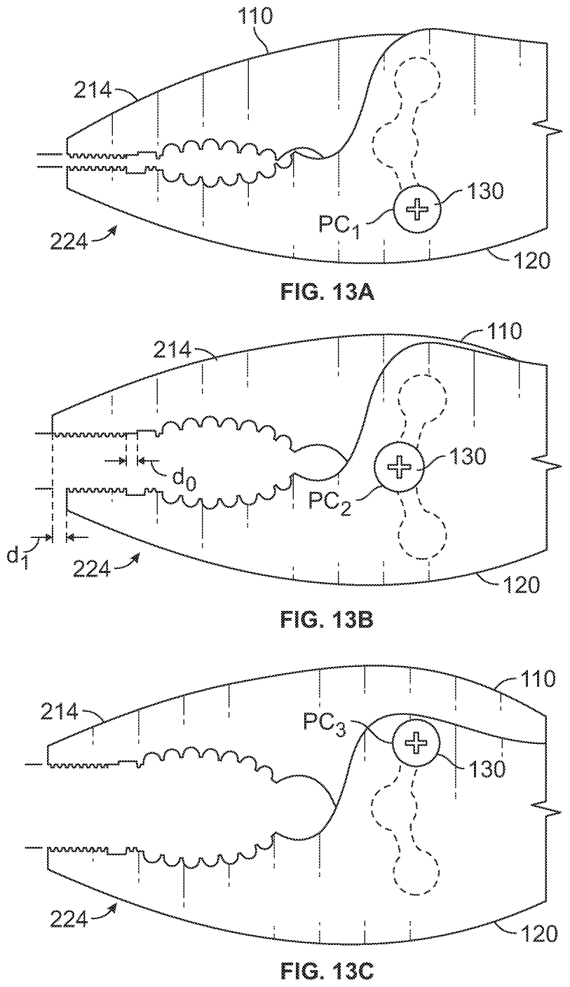

FIGS. 13A-13C shows three (3) enlarged views of another embodiment of a blunt nose 214, 224 of the first half 110, and the second half 120, respectively. FIG. 13A illustrates the first half 110 and the second half 120 when the pivot 130 is aligned with PC₁ of the slot 140. In this arrangement, the nose 214 of the first half 110, and the nose 224 of second half 120 are substantially parallel and positioned to accept a workpiece of width WP₁. FIG. 13B illustrates the first half 110 and the second half 120 when the pivot 130 is aligned with PC₂ of the slot 140. In this arrangement, the nose 214 of the first half 110, and the nose 224 of second half 120 are substantially parallel and positioned to accept a workpiece of width WP₂. FIG. 13C illustrates the first half 110 and the second half 120 when the pivot 130 is aligned with PC₃ of the slot 140. In this arrangement, the nose 214 of the first half 110, and the nose 224 of second half 120 are substantially parallel and positioned to accept a workpiece of width WP₃. In each of the views A-C, the stepped recess 150 and the recess 152 are aligned such that the first wall 184 within each reference is aligned or that the first wall 184 of the recess 152 is aligned with the second wall 186 defines as part of the step 154 in the stepped recess 150.

### II. A Plier with Alignable Groove

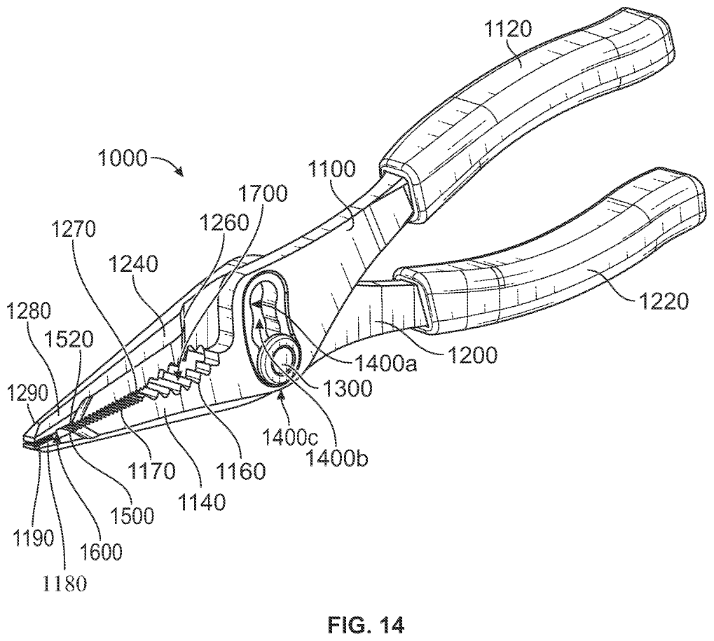

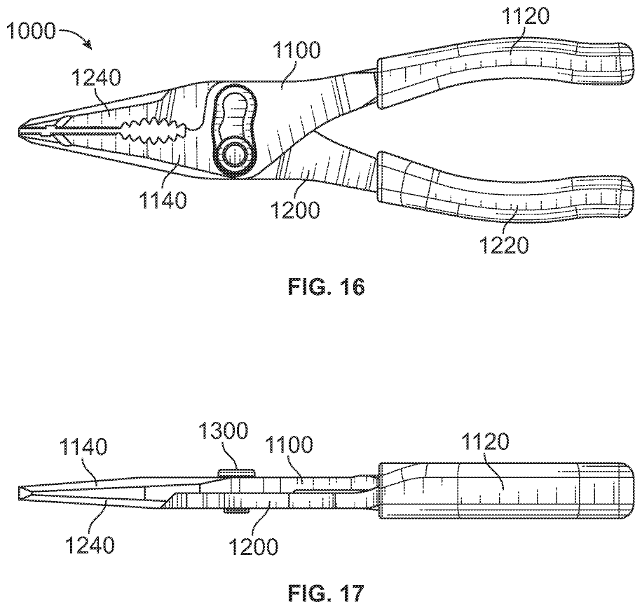

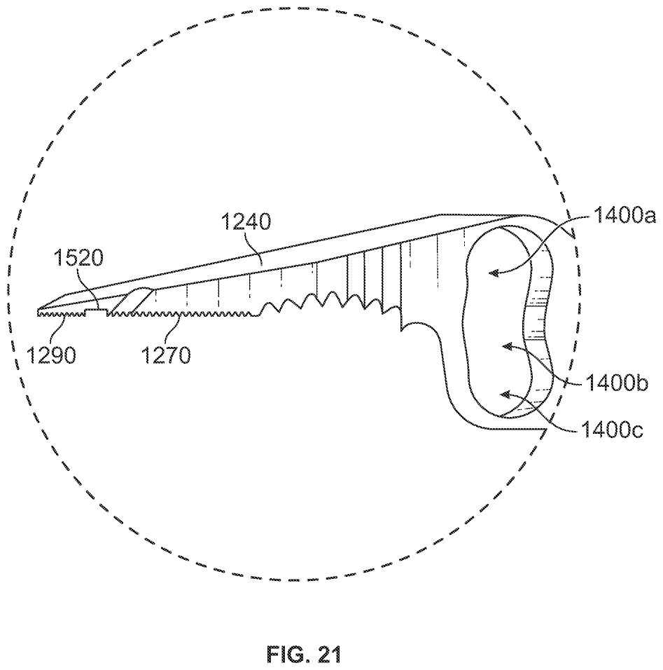

As shown in FIGS. 14-24, pliers 1000 includes plier half 1100 and plier half 1200 pivotable about pivot pin 1300. FIGS. 14-17 disclose various views of pliers 1000. Plier half 1100 includes handle 1120 and a nose 1140. Pivot adjustment holes 1400a, 1400b, and 1400c provide for positioning of plier half 1200 in three separate positions to adjust for workpieces of varying sizes. Nose 1140 includes gripping teeth 116, gripping grooves 1170, and gripping surface 1190. An elongated or recessed step 1500 is positioned between gripping grooves 1170 and gripping surface 1190 forming a gap therebetween. Plier half 1200 includes handle 1220 and a nose 1240. It will be appreciated that the use of the term “teeth”, “grooves”, and “surface” could all be used in place of one another in pliers 1000. Therefore, the use of any of those terms is defined as encompassing any of the two terms.

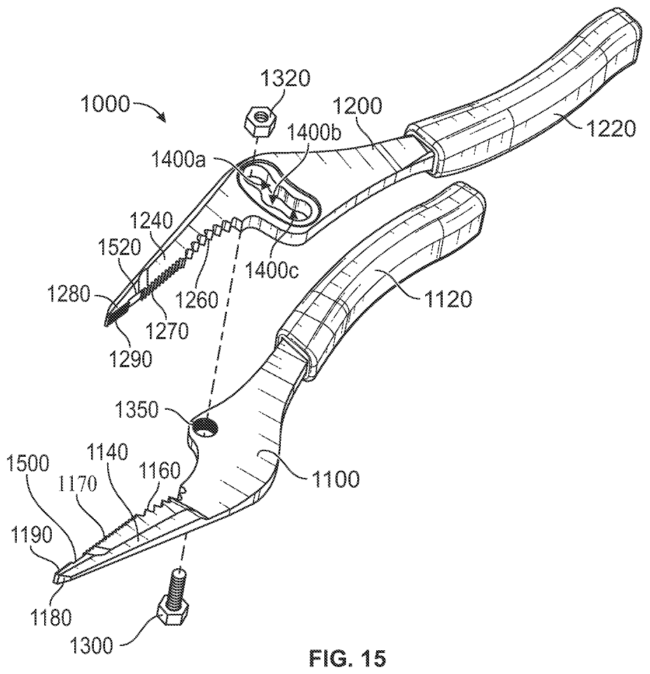

Plier half 1200 includes a pivot aperture (shown in FIG. 15) to allow for the passage of pivot pin 1300 therethrough. Nose 1240 includes gripping teeth 1260, gripping grooves 1270, and gripping surface 1290. An elongated recessed step 1520 is positioned between gripping grooves 1270 and gripping surface 1290 forming a gap therebetween. FIG. 15 shows that pivot pin 1300 and pivot pin nut 1320 are used to hold plier half 1100 and 1200 together.

When plier half 1100 and plier half 1200 are in a closed position as shown in FIG. 14, a primary aperture 1700 is formed between the gripping teeth 1160 and gripping grooves 1260. In addition, a secondary aperture 1600 is formed between elongated recessed step 1500 and elongated recessed step 1520. Secondary aperture 1600 is useful for accommodating workpieces that have an enlarged portion but are otherwise flat. For example, a fuse may have a protrusion that extends within the secondary aperture 1600 while the remainder of the fuse is generally flat. In other instances, when removing a workpiece using pliers 1000, a portion of the workpiece may extend through the secondary aperture 1600, and another portion may abut edges above the secondary aperture 1600 that provides for increased resistance to the workpiece slipping from the pliers during the removal process. In addition, the secondary aperture 1600 provides for a holding area for the pliers to hold a workpiece such as a cable or metal tube, which otherwise might slip from the jaw portions when under pressure, especially if the workpiece were slippery or oily. As another example, the secondary aperture 16000 may hold a round piece and reduce slipping of the round piece. The secondary aperture 1600 may allow applying a force evenly to the round piece. The secondary aperture 1600 may improve alignment, which may enable an even pulling force. In some examples, the round piece may be a hard work piece. Other examples are also possible.

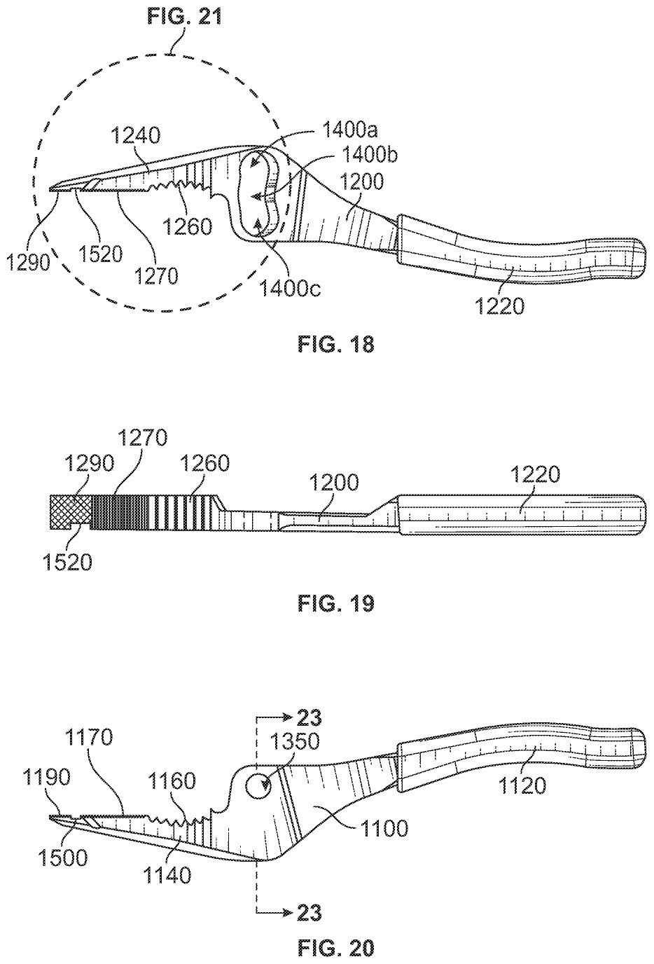

FIG. 18 is a top view of plier half 1200 which shows three pivot adjustment holes 1400a, 1400b, and 1400c more clearly. In FIGS. 18-19 and 21, elongated recessed step 1520 is shown between gripping grooves 1270 and gripping surface 1290. FIG. 20 is a side view of plier half 1100 which shows elongated recessed step 1500 positioned between gripping grooves 1270 and gripping surface 1290.

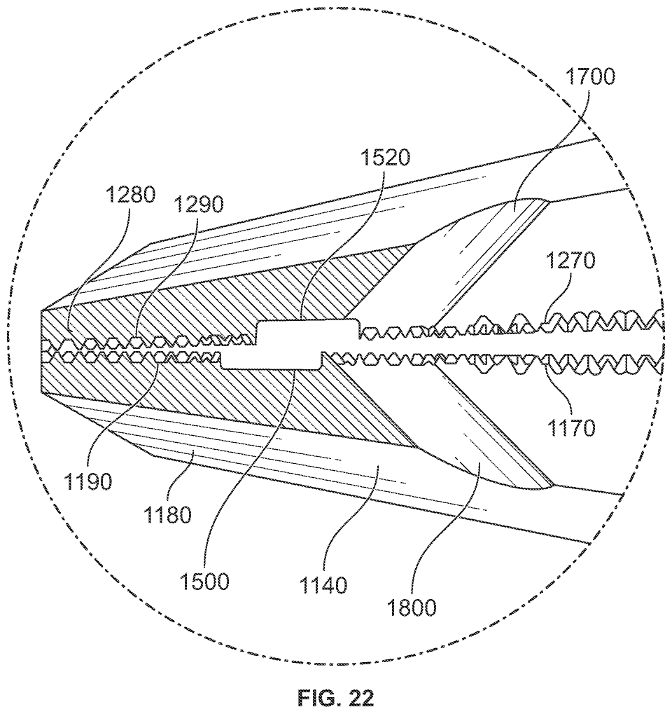

FIG. 22 is a close-up view of an end of pliers 1000. In some embodiments, elongated recesses 1500 and 1520 may be positioned in aligned position to form a uniform second aperture 1600, shown in FIG. 22 with a rectangular shape, although a rectangular shape or elongated recesses with a linear surface are not required. However, in FIG. 22, elongated recess 1500 is advantageously offset from elongated recess 1520 which provides for the positioning of an offset or non-uniform portion of a workpiece within secondary aperture 1600 that may not fit within a uniform aperture. As used herein, the term “offset” means that neither end of elongated recess 1500 and elongated 1520 are aligned. In addition, a secondary aperture 1600 that is formed when elongated recesses 1500 and 1520 are offset allows for the secondary aperture to serve as a holding area for a workpiece to be held at angle in the jaw portions of the pliers which allows for the workpiece to be more easily removed from, or inserted into, environments with a limited amount of space.

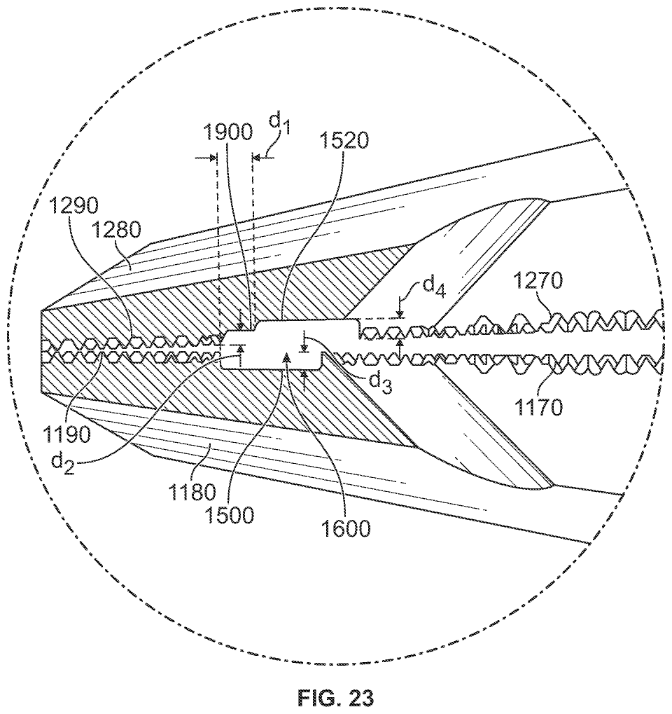

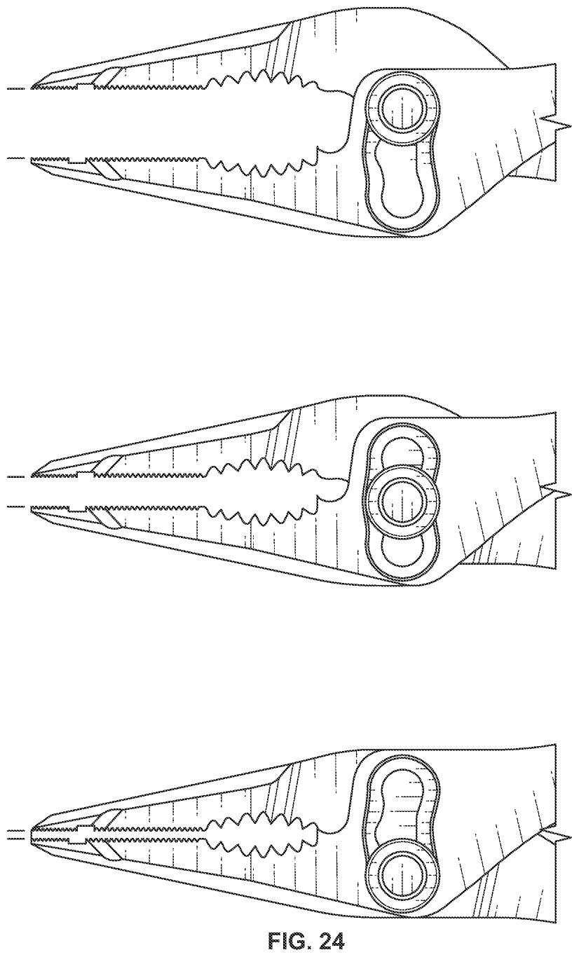

FIG. 23 is a close-up view of an alternate end for pliers 1000. In FIG. 23, a step 1900 advantageously extends from elongated recess 1520 and ends at a point that is aligned above an end of elongated recess 1500. In FIG. 23, elongated recess 1500 and 1520 form a secondary aperture 1950. Given that when using a step 1900, the outermost ends of elongated recesses 1500 and 1520 are aligned, secondary aperture can be said to be “half-offset.” Furthermore, the depth of elongated recess 1520 is less above step 1900 than the remainder of elongated recess 1520, which provides for the ability to handle workpieces that have a non-uniform shape when extending through secondary aperture 1950. A work piece having a uniform shape, such as a fuse, may line up with the step 1900. The step 1900 may allow a uniform piece, such as a round piece, to bear against the elongated recesses 1500, 1520.

FIG. 23 provides various dimensions for the geometric configuration of secondary aperture 1950. Dimension d₁ shows the length of step 1900 which may have a varied length, dimension d₂ shows the distance between the top of step 190 and the top of gripping surface 129, dimension d₃ shows the depth of elongated recess 1500, and dimension d₄ shows the depth of elongated recess 1520. Dimensions d₁-d₄ may vary and are shown only for exemplary purposes.

FIG. 24 is a view of pliers 1000 in a closed position, middle position, and fully open position.

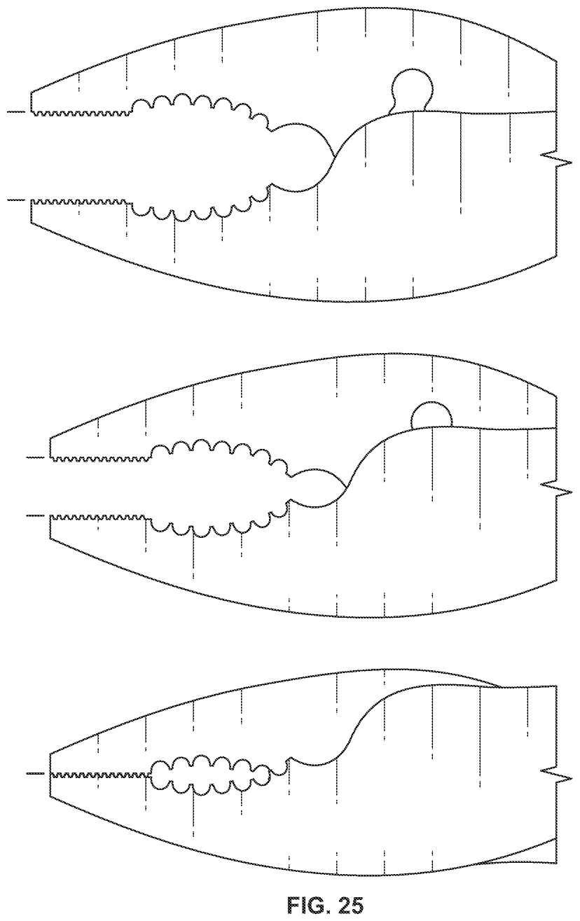

FIG. 25 shows illustrations of a top view of an end of pliers in three different positions. The bottom illustration shows the pliers in a closed position, the middle illustration shows the pliers in a middle position, and the top illustration shows the pliers in a fully open position. In the closed position, the end of the left jaw and the end of the right jaw line up without using the step. Further, in the fully open position, the end of the left jaw and the end of the right jaw line up without using the step. In the middle position, the step lines up with the smallest tooth on the left jaw. In the middle position, the back end of the tooth acts a ledge. Further, in the middle position, the top of the large teeth act as one ledge. The arrangement of the ends of the plier halves in FIG. 25 may improve pulling of the pliers.

In pliers 1000, a single intermediate pivot center 1400b connects to pivot centers 1400a and 1400c. The center line of each of the two slots intersect to form an angle (a) having a measure in the range of from about 175 degrees to about 160 degrees. Preferably, the angle (a) is in the range of from about 170 degrees to about 166 degrees, and most preferably the angle (a) is about 168 degrees. The angle (a) creates a pathway for a pivot pin 1300 which requires a slight direction change as it passes through intermediate pivot center 1400b from either terminal pivot center 1400a or 1400c.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

### IV. Conclusion

It should be understood that the arrangements described herein and/or shown in the drawings are for purposes of example only and are not intended to be limiting. As such, those skilled in the art will appreciate that other arrangements and elements (e.g., machines, interfaces, functions, orders, and/or groupings of functions) can be used instead, and some elements can be omitted altogether.

While various aspects and embodiments are described herein, other aspects and embodiments will be apparent to those skilled in the art. The various aspects and embodiments disclosed herein are for purposes of illustration and are not intended to be limiting, with the true scope being indicated by the claims, along with the full scope of equivalents to which such claims are entitled. It is also to be understood that the terminology used herein for the purpose of describing embodiments only, and is not intended to be limiting.

In this description, the articles “a,” “an,” and “the” are used to introduce elements and/or functions of the example embodiments. The intent of using those articles is that there is one or more of the introduced elements and/or functions.

In this description, the intent of using the term “and/or” within a list of at least two elements or functions and the intent of using the terms “at least one of,” “at least one of the following,” “one or more of,” “one or more from among,” and “one or more of the following” immediately preceding a list of at least two components or functions is to cover each embodiment including a listed component or function independently and each embodiment including a combination of the listed components or functions. For example, an embodiment described as including A, B, and/or C, or at least one of A, B, and C, or at least one of: A, B, and C, or at least one of A, B, or C, or at least one of: A, B, or C, or one or more of A, B, and C, or one or more of: A, B, and C, or one or more of A, B, or C, or one or more of: A, B, or C is intended to cover each of the following possible embodiments: (i) an embodiment including A, but not B and not C, (ii) an embodiment including B, but not A and not C, (iii) an embodiment including C, but not A and not B, (iv) an embodiment including A and B, but not C, (v) an embodiment including A and C, but not B, (v) an embodiment including B and C, but not A, and/or (vi) an embodiment including A, B, and C. For the embodiments including component or function A, the embodiments can include one A or multiple A. For the embodiments including component or function B, the embodiments can include one B or multiple B. For the embodiments including component or function C, the embodiments can include one C or multiple C. In accordance with the aforementioned example and at least some of the example embodiments, “A” can represent a component, “B” can represent a system, and “C” can represent a symptom.

The use of ordinal numbers such as “first,” “second,” “third” and so on is to distinguish respective elements rather than to denote an order of those elements unless the context of using those terms explicitly indicates otherwise. Further, the description of a “first” element, such as a first plate, does not necessitate the presence of a second or any other element, such as a second plate.

What is claimed is:

1. Adjustable pliers comprising:
first and second plier halves, each including a central section with a nose and a handle extending therefrom;
each central section being pivotably connected to one another by a pivot pin attached to one of the plier halves and fitted for travel within a slot defined within the other of the plier halves;
the slot comprising a plurality of pivot centers, including two non-adjacent terminal pivot centers and at least one intermediate pivot center, each pivot center being connected to at least one other pivot center by the slot to form a single pathway, whereby travel of the pivot pin between non-adjacent pivot centers requires travel through at least one of the at least one intermediate pivot centers;
each nose of a plier half having an end distal from the central section and a work area adjacent the work area of the other plier, the work area defining substantially square shoulder indentation between 2″ and 1.50″ from the end; and
the plier halves being configured so that, with the pivot pin in either of the terminal pivot centers and the adjustable tool in a working position, the work areas of each plier half are substantially parallel to one another and the shoulder indentations of each plier half are substantially aligned.

2. Adjustable pliers comprising:
a first plier half and a second plier half, each including a central section with a nose and a handle extending therefrom;
each central section being pivotably connected to one another by a pivot pin attached to one of the plier halves and fitted for travel within a slot defined within the other of the plier halves;
the slot comprising a plurality of pivot centers, including two non-adjacent terminal pivot centers and at least one intermediate pivot center, each pivot center being connected to at least one other pivot center by the slot to form a single pathway, whereby travel of the pivot pin between non-adjacent pivot centers requires travel through at least one of the at least one intermediate pivot centers;
wherein the first plier half includes first gripping teeth, first gripping grooves, and a first gripping surface;
wherein the second plier half includes second gripping teeth, second gripping grooves, and a second gripping surface;
wherein the first plier half includes a first elongated recess positioned between the gripping grooves and the gripping surface, and the second plier half includes a second elongated recess positioned between the gripping grooves and the gripping surface;
wherein when the first and second plier halves are in a closed position, a primary aperture is formed between the gripping teeth on the first plier half and the gripping teeth on the second plier half; and
wherein a secondary aperture is formed between the elongated recess of the first plier half and the elongated recess of the second plier half.

3. The adjustable pliers of claim 2, wherein the secondary aperture is offset.

4. The adjustable pliers of claim 2, wherein a step extends from the first elongated recess.

5. The adjustable pliers of claim 4, wherein an end of the step is aligned with an outermost end of the second elongated recess.

6. The adjustable pliers of claim 5, wherein the secondary aperture is half-offset.

7. An adjustable hand tool comprising:
a first tool half including a central section extending between a tool nose and a tool handle, wherein the central section includes a fixed pivot;
a second tool half including a central section extending between a tool nose and a tool handle, wherein the central section includes a slot having a plurality of pivot centers, and wherein the slot and plurality of pivot centers are sized to slideably engage the fixed pivot thereby allowing travel along the slot;
a first gripping surface positioned at the tool nose of the first tool half, wherein the first gripping surface includes a stepped recess positioned between a fine grip section and a coarse grip section;
a second gripping surface positioned at the tool nose of the second tool half, wherein the first gripping surface includes a recess positioned between a fine grip section and a coarse grip section, wherein the recess is positioned substantially opposite to the stepped recess when the fixed pivot is engaged by the slot; and
wherein the stepped recess and the recess define an aperture when the fixed pivot is positioned at one of the plurality of pivot centers, and a step of the stepped recess and the recess define another aperture when the fixed pivot is positioned at an adjacent one of the plurality of pivot centers.

8. The adjustable hand tool of claim 7, wherein the first tool half and the second tool half extend along a longitudinal axis between the tool nose and the tool handle.

9. The adjustable hand tool of claim 8, wherein the stepped recess and the recess formed transverse to the longitudinal axis between the tool nose and the tool handle.

10. The adjustable hand tool of claim 7, wherein the tool handle includes brake.

11. The adjustable hand tool of claim 7, wherein the plurality of pivot centers specifies an offset between two adjacent pivot centers defined as part of the plurality of pivot centers.

12. The adjustable hand tool of claim 11, wherein the step of the stepped recess includes a width that is substantially equal to the offset.

13. The adjustable hand tool of claim 7, wherein the recess is positioned substantially opposite to and aligned with the stepped recess when the fixed pivot is positioned one of the plurality of pivot centers.

14. The adjustable hand tool of claim 14, wherein the recess is positioned substantially opposite to and aligned with the step of the stepped recess when the fixed pivot is positioned at the adjacent one of the plurality of pivot centers.

15. The adjustable hand tool of claim 7, wherein the fixed pivot cooperates with a pivot pin nut to secure the first tool half to the second tool half.

16. The adjustable hand tool of claim 7, wherein the fixed pivot is a shoulder bolt.

17. The adjustable hand tool of claim 7, wherein the fine grip section of the first gripping surface and the second gripping surface is a fine serration.

18. The adjustable hand tool of claim 17, wherein the coarse grip section of the first gripping surface and the second gripping surface is a coarse serration.

19. The adjustable hand tool of claim 7, wherein the slot having the plurality of pivot centers further includes two non-adjacent terminal pivot centers and at least one intermediate pivot center, each pivot center being connected to at least one other pivot center by the slot to form a single pathway.

20. The adjustable hand tool of claim 19, wherein the single pathway allows travel of the pivot pin between non-adjacent pivot centers via travel through at least one of the at least one intermediate pivot centers.
